(19) United States
(12) Patent Application Publication
(10) Pub. No.: US 2007/0101018 A1
(43) Pub. Date: May 3, 2007

(54) Inter-domain QoS reservation establishment and modification

(76) Inventors: Meral Shirazipour, Brossard (CA); Yves Lemieux, Kirkland (CA)

Correspondence Address: ALEX NICOLAESCU;Ericsson Canada Inc., Patent Department, 8400 Decarie Blvd., Town Mount Royal, QC, H4P 2N2, CA

(21) Appl. No.: 11/262,732

(22) Filed: Nov. 1, 2005

(51) Int. Cl. G06F 15/173

(52) U.S. Cl. 709/238

(57) ABSTRACT

A Resource Manager node and methods for establishing and modifying an inter-domain QoS reservation between a first node in a first domain and a further node in a further domain. After detection that the QoS reservation with at least one QoS characteristic is needed or needs to be refreshed, obtaining, at the first node, network state information associated to at least one possible choice of path between the first domain and the further domain. Thereafter, determining at least one choice of path between the first domain and the second domain in view of the at least one QoS characteristic, selecting a selected path to support the QoS reservation and sending a reservation message to trigger establishment of the inter-domain QoS reservation.

### BACKGROUND OF THE INVENTION

1. Field of the Invention

The present invention relates to Quality of Service (QoS) for packet traffic and, more particularly, to establishing and modifying a QoS guarantee for packet traffic transiting through more than one sub network also referred to as Autonomous System (AS).

2. Description of the Related Art

At the moment there is a trend toward all-Internet Protocol (IP) communication. However, IP has been based on a best effort paradigm by which traffic is served in a first-in first-out (FIFO) manner. The problem comes from the fact that time-sensitive services require a minimal quality of service (QoS) guarantee. Many solutions were developed to address the problem. In the end, it all aims at getting the best performance from the IP network while optimizing its resource utilization. That is often referred to as traffic engineering. Most traffic engineering techniques are based on the assumption that the engineered traffic will remain within one or few IP networks under a common administration. However, most time-sensitive services will usually span across more than one autonomous system (AS) (typically two to eight AS according to current state of research (e.g. PhD thesis from Pan Ping in 2002)). This implies that traffic engineering techniques need to support the traffic across more than one AS.

Unfortunately, little work has been done in the inter-AS or inter-domain traffic engineering field. Many techniques rely on the use of Border Gateway Protocol (BGP), which is the inter-domain routing protocol used in IP networks. BGP is defined at length by the Internet Engineering Task Force (IETF) under the Request For Comment (RFC) number 1771 and 1772, which is herein included by reference. The current inter-domain traffic engineering techniques make use of common BGP path attributes to prefer some inter-domain routes to others. However, these techniques do not provide sufficient reliability to support time-sensitive services, which require a QoS guarantee not only from each of the traversed AS, but also on an overall end-to-end perspective. Moreover, some further aspects of an acceptable solution are not present in the current inter-domain traffic engineering techniques. For instance, there is a lack granularity that prevents per flow discrimination of QoS.

Moreover, some further aspects of an acceptable solution are not present in the current inter-domain traffic engineering techniques. For instance, there is a lack granularity that translates, in practice, into difficulty to address sub portions of the end-to-end QoS assignment. There is also an insufficiency of the current inter-domain traffic engineering techniques to provide a robust, flexible and scalable solution. That is to say that the current solutions do not allow for an increase of traffic related to a specific time-sensitive service. Furthermore, the possibility of hardware failure is not appropriately addressed and it is not possible to modify the time-sensitive service's guaranteed QoS during the course of a given service instance.

Multi-Protocol Label Switching (MPLS) is currently used in various network configurations in order to provide a simple and efficient forwarding mechanism in packet switched networks. One main feature of MPLS is to associate all packets related to a single communication on a specific path by using a specific label. Once the path is established using a Resource ReserVation Protocol (RSVP), MPLS enabled-routers then simply have to forward all packets in accordance with their respective label. A complete overview of MPLS and RSVP can be obtained at the IETF under the RFC number 3031 for MPLS and 2205, 2750 and 3209 for RSVP, all of which are herein included by reference. However, MPLS as known today is typically deployed inside a uniquely administrated network or Autonomous System (AS) because of, among other reasons, the label attribution mechanism. The only example of inter domain MPLS deployment is between two nodes from two different ASs for reachability purposes, as opposed to QoS purposes.

As can be appreciated, the current inter-domain traffic engineering techniques fall short at providing an updatable inter-domain traffic engineering solution that would fulfill the needs of time-sensitive services that are provided over multiple AS.

### SUMMARY OF THE INVENTION

A first aspect of the present invention is directed to a method for establishing an inter-domain QoS reservation between a first node in a first domain and a second node in a second domain. The first and second domains are connected via a series of routers. The method comprises the steps of detecting, at the first node, that the inter-domain QoS reservation with at least one QoS characteristic is needed, obtaining, at the first node, network state information associated to the first domain and obtaining, at the first node, network state information associated to at least one possible choice of path between the first domain and the second domain. Thereafter, the method follows with the steps of determining, at the first node, at least one choice of path between the first node and the second node in view of the at least one QoS characteristic, selecting, at the first node, from the at least one choice of path a selected path to support the inter-domain QoS reservation and sending, from the first node and addressed to the second node, a reservation message to trigger establishment of the inter-domain QoS reservation.

Optionally, the step of determining could be performed by determining, at the first node, at least one choice of end-to-end path between the first node and the second node respecting the at least one QoS characteristic. It could also alternatively comprise concatenating, at the first node, the network state information associated to the first domain with the network state information associated to the at least one possible choice of path between the first domain and the second domain in order to determine if the at least one choice of end-to-end path respecting the at least one QoS characteristics exists and also potentially comprise calculating, at the first node, a QoS value for each of at least one path external to the first domain toward the second node.

The step of obtaining network state information associated to the first domain could further comprise sending, from the first node and addressed to an intermediate node of the first domain from the series of routers, a temporary request message to temporarily reserve resource for eventual establishment of the inter-domain QoS reservation and receiving a tentative reservation message from the intermediate node of the first domain, the tentative reservation message comprising the network state information associated to the first domain is included.

Similarly, the step of obtaining network state information associated to the at least one possible choice of path between the first domain and the second domain could further comprises sending, from the first node and addressed to an intermediate node outside the first domain from the series of routers, a temporary request message to temporarily reserve resource for eventual establishment of the inter-domain QoS reservation and receiving a tentative reservation message from the intermediate node outside the first domain, the tentative reservation message comprising the network state information associated the at least one possible choice of path between the first domain and the second domain is included. The step could also be performed by obtaining information related to the at least one QoS characteristic reservation from an existing table.

Another optional implementation suggests that the step of sending the reservation message could further comprise sending, from the first node and addressed to the second node, a confirm request message, the confirm request message comprising sufficient information to be routed in accordance with the select path and receiving a reservation confirm message, which established the inter-domain QoS reservation on its path from the second node to the first node.

The method could further be executed again starting from the step of determining if a reservation confirm message is not received at the first node after a specific period following the step of sending the reservation message.

A second aspect of the present invention is directed to a method for modifying an established inter-domain QoS reservation maintained on an end-to-end path between a first node in a first domain and a second node in a second domain. The first and second domains are connected via a series of routers. The method comprises the steps of detecting, at an intermediate node of the series of routers, that the inter-domain QoS reservation with at least one QoS characteristic needs to be refreshed, obtaining, at the intermediate node, network state information associated to its domain and, if the domain of the intermediate node is not the second domain, obtaining, at the intermediate node, network state information associated to at least one possible choice of path between the domain of the intermediate node and the second domain. The method then follows with the steps of determining, at the intermediate node, at least one alternate choice of path between the intermediate node and the second node respecting the at least one QoS characteristic, selecting, at the intermediate node, from the at least one alternate choice of path a selected path to support the inter-domain QoS reservation and, if the selected path changes the end-to-end path of the inter-domain QoS reservation toward the second node, sending, from the intermediate node and addressed to the second node, a reservation message to trigger establishment of the inter-domain QoS reservation.

Optionally, the could further comprise the steps of, after detecting, verifying that the intermediate node can find an alternate path toward the second node and if it cannot, sending a notify message from the intermediate node toward the first node via the series of routers, the notify message comprising sufficient information to let a further node of the series of routers know that the inter-domain QoS reservation with at least one QoS characteristic needs to be refreshed.

The method could also further comprise a step of, if the selected path does not change the end-to-end path of the inter-domain QoS reservation toward the second node, sending a notify message from the intermediate node toward the first node via the series of routers, the notify message comprising sufficient information to let a further node of the series of routers know that the inter-domain QoS reservation with at least one QoS characteristic needs to be refreshed.

A third aspect of the present invention is directed to a Resource Manager Node (RM) for establishing and modifying an inter-domain QoS reservation on an end-to-end path between a first node in a first domain and a second node in a second domain. The RM is on the end-to-end path and comprises a reservation module and an Option calculation module.

The reservation module detects that the inter-domain QoS reservation with at least one QoS characteristic is either needed or needs to be refreshed, obtains network state information associated to at least one possible choice of path between the RM and the second domain and sends, from the RM and addressed to the second node, a reservation message to trigger establishment of the inter-domain QoS reservation.

The Option calculation module determines at least one choice of path between the RM and the second node respecting the at least one QoS characteristic and selects from the at least one choice of path a selected path to support the inter-domain QoS reservation.

### BRIEF DESCRIPTION OF THE DRAWINGS

A more complete understanding of the present invention may be obtained by reference to the following Detailed Description when taken in conjunction with the accompanying drawings wherein:

FIG. 1 is an exemplary network topology in accordance with the teachings of the present invention;

FIG. 2 is a flow chart of the algorithm to establish a QoS Reservation between a first node in a first AS and a second node in a second AS in accordance with the teachings of the present invention;

FIG. 3 is a flow chart of the algorithm to modify a QoS Reservation between a first node in a first AS and a second node in a second AS in accordance with the teachings of the present invention;

FIG. 4 is a message sequence flow chart of an exemplary setup and update of a QoS reservation between a first node in a first AS and a second node in a second AS in accordance with the teachings of the present invention; and

FIG. 5 is a modular representation of a Resource Manager Node in accordance with the teachings of the present invention.

### DETAILED DESCRIPTION OF THE PREFERRED EMBODIMENTS

The present invention proposes a mechanism to optimize establishment of inter domain QoS reservation and to optimize rearrangement of already established inter domain QoS reservation. In order to do so, the present invention proposes deployment of at least one Resource Manager Node along a given inter domain QoS reservation. As a prerequisite, the Resource Manager Node needs to be aware of the topology of the network it is part of or, in other words, of its AS′ topology. In the context of inter domain QoS reservation, the topology knowledge of the Resource Manager Node is then used to predict QoS treatment of packets sent within its AS. This includes prediction of the QoS treatment of packets sent through its AS, i.e. from a first border router to a second border router of its AS. A major role of the Resource Manager Node is thus to use various types of information known about its AS to optimize a QoS reservation initiated, transiting or terminating therethrough. The functionalities of the Resource Manager Node are likely to reside in a router and more particularly in a border router since this location is advantageous due to the larger routing responsibility. However, the Resource Manager Node could also be co-located or simply connected to a routing equipment without affecting the teachings of the present invention.

Since the underlying structure is likely to be a router and since one of the purposes of the Resource Manager Node is to compute path reservation, the teachings of the present invention could also be seen as an extension of the work in progress known under the name of Path Computation Element (PCE) at the IETF. In the context of specifying how information related to a given AS topology should circulate within the AS and between ASs, the IETF has made an attempt at defining a request-response protocol in ‘draft-ietf-pce-architecture-02.txt’ herein included by reference. The ‘draft-ietf-pce-architecture-02.txt’ document mainly aims at providing a set of building blocks for the PCE architecture (framework) as compared to the inter-domain QoS reservation focus of the present invention. A further document ‘draft-ietf-pce-comm-protocol-gen-reqs-02.txt’ from the IETF lists the requirements for which technical solutions as yet to be provided. The following description is made generic, but the reader is further invited to read it also in the context of PCE. Therefore, PCE is likely to be mentioned as one alternative in the following description. However, omission of mentioning the details of implementation from a strict PCE perspective does not mean that the related teachings cannot be applied thereto.

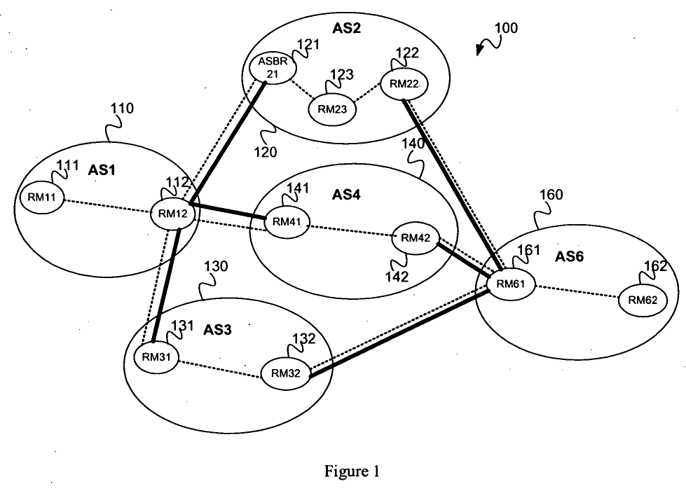

FIG. 1 shows an exemplary network 100 topology in accordance with the teachings of the present invention. FIG. 1 shows six Autonomous Systems AS1 110, AS2 120, AS3 130, AS4 140 and AS6 160. Only border routers and Resource Manager Nodes (RMs) are shown interconnected in the ASs 110-160 since the teachings of the present invention are mainly aimed at improving those, but it should be understood that the ASs are likely to contain further nodes, which make use of the border routers and RMs capabilities provided by the various nodes shown (further nodes such as intermediate routers, terminating nodes, service nodes, database nodes, etc.). A border router enables connection of the AS in which it resides toward other systems (e.g. other ASs as shown on FIG. 1, but also third party service provider, single node, etc.). The AS1 110 comprises two RMs also acting as border routers RM11 111 and RM12 112. The AS2 120 comprises one border router ASBR21 121 and two RMs RM22 122 and RM23 123, where the RM22 122 also acts as a border router. The AS3 130 to AS6 160 respectively comprises two RMs also acting as border routers RM31 131 and RM32 132, RM41 141 and RM42 142 and RM61 161 and RM62 162. Various links are further shown connecting the various nodes in their respective AS. It should be understood that the type of link and related connection occurring thereon do not affect the teachings of the present invention. The ASs 110-160 are further interconnected, when appropriate, via inter-domain links (e.g. based on geographical proximity or networking needs between sites) through their respective border routers as shown by the thicker black lines on FIG. 1. In comparison, the dotted lines on FIG. 1 represent logical connections, on which intermediates nodes are likely to be present. It should also be noted, even if the Resource Manager functionalities are shown only within the RMs 111-162, the Resource Manager functionality could, be co-located to the RMs (not explicitly shown on FIG. 1) or made available to the RM via a link or set of API (e.g. Remote Procedure Call (RPC), Common Object Request Broker Architecture (CORBA) interfaces, etc.) (not explicitly shown on FIG. 1). In the following discussion, the terms domain and AS are used to designate a single concept of network or sub network administered by one administrative entity.

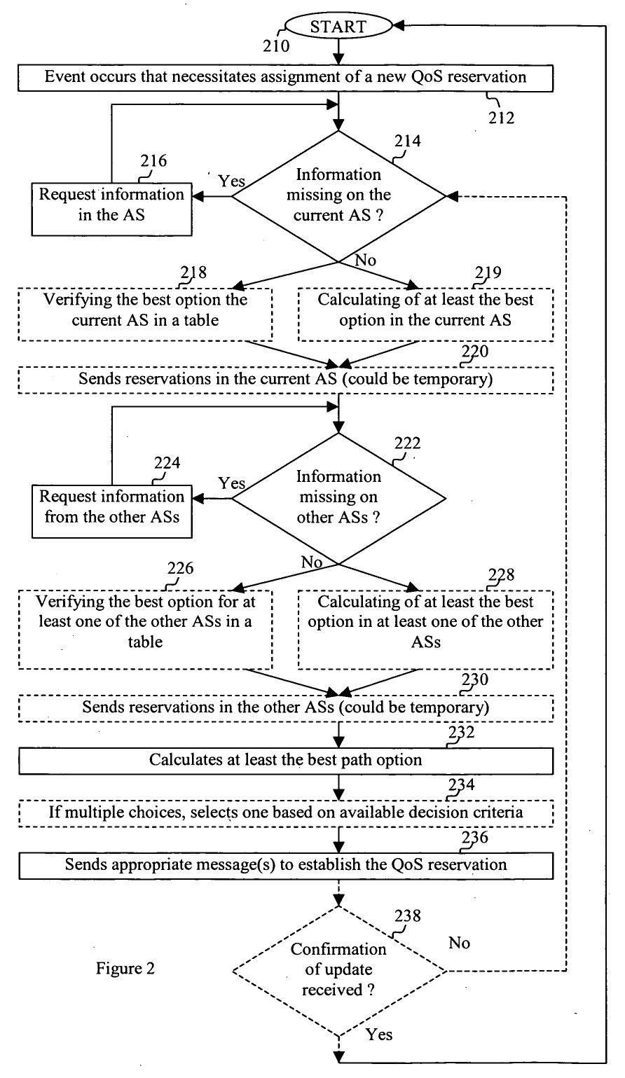

FIG. 2 shows a first exemplary algorithm that can be used by a Resource Manager Node (RM) in accordance with the teachings of the present invention to establish a QoS Reservation between a first node in a first AS to a terminal node in a terminal AS. The algorithm starts at the RM (step 210) with a stable situation (e.g. no pending request to be treated, etc.). The RM then detects or receives necessary information concerning an event that necessitates establishment of an inter-domain QoS reservation (step 212) toward the terminal node of the terminal domain (e.g. to connect with a destination node reachable through the terminal domain). During the same step, the RM associates at least one QoS characteristics required by the inter-domain reservation. Among the many events that can cause such a response, examples are reception of a specific message to the effect of inter-domain reservation from a further RM (i.e. the RM is an intermediate RM on the inter-domain QoS reservation), reception of a specific message to the effect of inter-domain reservation from an end node, reception of a packet destined to a further domain, occurrence of a preset condition on traffic load, etc. Examples of QoS characteristics include minimal bandwidth required, maximum delay or delay-jitter tolerated, maximum loss-rate tolerated, etc. At this point, the RM assesses if it has all required information to compute at least one sub-path in its own or current AS for the inter-domain QoS reservation (step 214). Required information, in the present context, is assimilated to various kinds of network state information and is evaluated at least in view of the required QoS characteristic(s). The required information can be acquired through an existing network management system (e.g. Simple Network Management Protocol (SNMP)), a proprietary request-response protocol, a passive push-type protocol or an active pull-type protocol, etc. One example of required information is a table listing at least one QoS characteristic for each border router of the current AS. Thus, the step 214 may or may not be necessary to achieve the present invention (i.e. not necessary in cases of push-type protocol). If the RM does not have all required information, it requests information from within the current AS to complete the required information (step 216). Thereafter, it can be said that the RM obtained network state information concerning the current AS (either actively or passively).

From this point on, the RM can decide to act to reserve resource for the inter-domain QoS reservation in the current AS. In such a case, the RM either verifies the best sub-path for the inter-domain QoS reservation in an existing table as exemplified above (step 218) or calculates at least one best sub-path option with the current AS for the inter-domain QoS reservation (step 219). The RM could then send appropriate messaging (step 220) to at least temporarily reserve resource for the inter-domain QoS reservation. The steps 218-220 could also be avoided if it is more advantageous to wait for more details about the inter-domain QoS reservation before taking a decision. For instance, the decision to reserve in step 218-220 could be taken only after reception of required information on a maximal number of possibilities of complete end-to-end path before deciding which of the current AS′ should be used to reach the destination through the inter-domain QoS reservation. It is hard to predict what the maximum number of possibilities is likely to be since it largely depends on network topology. For instance, it might happen that only one possibility exist and it might also happen that a decision is taken even if information concerning some choices are not yet available.

Then, the RM assesses if it has all required information to compute at least one sub-path in the other ASs for the inter-domain QoS reservation (step 222). Just as before, the RM requests information if necessary (step 224). The step 222 may not be necessary if the RM is located in the domain in which the final node involved in the inter-domain QoS reservation is located (terminal AS). ). Thereafter, it can be said that the RM obtained network state information concerning the other ASs potentially involved in the inter-domain QoS reservation (either actively or passively).

At this point on, the RM can decide to act to reserve resource for the inter-domain QoS reservation in the other ASs. In such a case, the RM either verifies the best sub-path for the inter-domain QoS reservation in an existing table (step 226) or calculates at least one best sub-path option with the current AS for the inter-domain QoS reservation (step 228). The RM could then send appropriate messaging (step 230) to at least temporarily reserve resource for the inter-domain QoS reservation. The steps 226-230 could also be avoided if it is more advantageous to wait for more details about the inter-domain QoS reservation before taking a decision. The same reasoning concerning timing and location issue of the decision(s) to reserve or to postpone reservation as discussed with relation to step 218-220 also apply here.

The RM, having obtained network state information for the current AS and at least one option toward the terminal domain, determines or calculates at least the best path option for the inter-domain QoS reservation (step 232). This can be achieved by analyzing network state information received from only the current AS and a next domain on the inter-domain QoS reservation without having knowledge of the network state information of the other domains involved (implying a delegation of the decision authority from the source domain down toward the terminal domain). A best path, in this context, is obtained through the domain providing the best performance in view of the required QoS characteristic. Step 232 can also be achieved by analyzing network state information received from the current AS and other domains on the inter-domain QoS reservation by which at least one best end-to-end path options exists (the decision authority is thus maintained in the source domain). If more than one choice exists for the path determined or calculated in the step 232, the RM decides which one is chosen based on, if necessary or applicable, further decision criteria, step 234 (e.g. costs of links (e.g. depending on the time), technology preference, Service Level Agreement (SLA), etc.). The step 234 could be further minimized by moving some criteria under the QoS characteristic subject.

The RM then sends appropriate messages to reserve the resources for the inter-domain QoS reservation, based on the decision of step 232 and 234 (step 236). Depending on the type of protocol used to send the reservation messages, the RM might then wait for confirmation messages (step 238) for a certain maximum period of time before returning to the stable situation (step 210). If confirmation messages are not all received, the RM could decide to go back to step 214 (or further intermediate step depending on whether other confirmation messages were received and from which nodes) to recalculate a valid scenario. If confirmation messages are not required, the RM returns to 210 after step 236.

The inter-domain QoS reservation is then reserved. In some protocols, a final step of conversion of the inter-domain QoS reservation into a routable format (e.g. MPLS′ LSP label establishment) could be necessary. However, the necessary information could also be further included in the messages exchanged during the setup of the inter-domain QoS reservation.

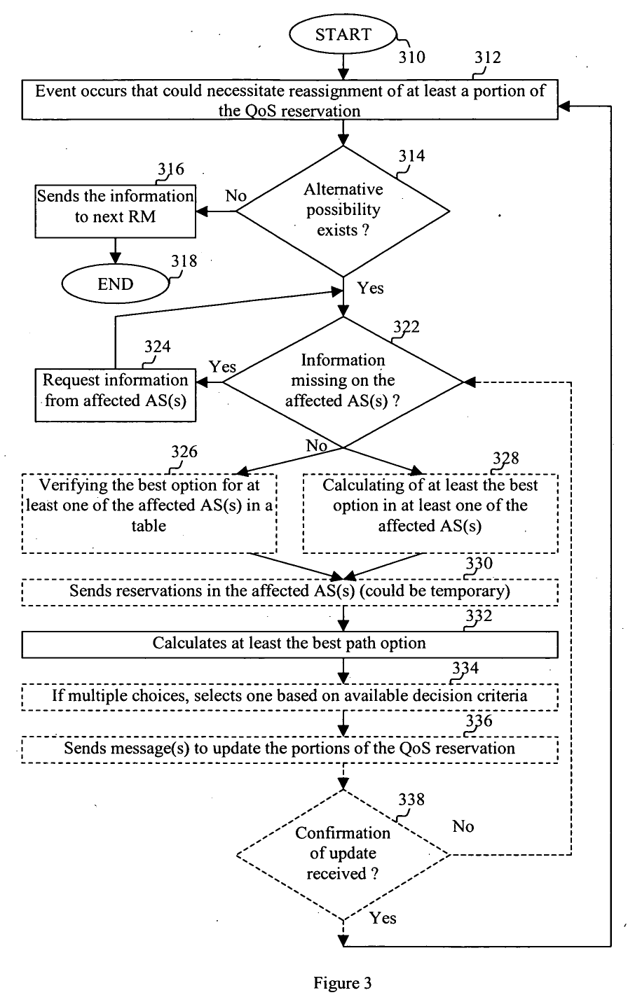

FIG. 3 shows a first exemplary algorithm that can be used by a RM in accordance with the teachings of the present invention to modify an inter-domain QoS reservation between a first node in a first AS to a terminal node in a terminal AS. The RM is in a stable situation, with regard to FIG. 3, when an inter-domain QoS reservation exists (step 310). From thereon, the RM detects that the inter-domain QoS reservation should be refreshed (step 312). In other words, there is a need to evaluate reassignment of at least a portion of the inter-domain QoS reservation. Just as for step 212 of FIG. 2, the detection is likely to occur through occurrence of an event, which can take various forms (e.g. expiration of a timer, QoS characteristic not met anymore, broken link, new link, change of costs of sub-links, etc.). The RM can then possibly evaluate if it can reach the terminal domain via another path (step 314). If it cannot, it sends the information to the next level of RM (step 316) and ends the algorithm (step 318). It is however fairly possible that the RM will only know if it can reach the terminal domain via another path only after completion of further steps of the algorithm. Therefore, the steps 318-320 can be executed later in the algorithm, whenever information acquired by the RM enables such a decision to be taken. From then on, the steps 322-338 are virtually identical to steps 222-238. Even if many similarities exist with the preceding example concerning the establishment phase, it should be understood that choices made (e.g. decision location and timing as discussed with relation to steps 218-220 of FIG. 2) for establishment algorithm are not inevitably made for the modification algorithm.

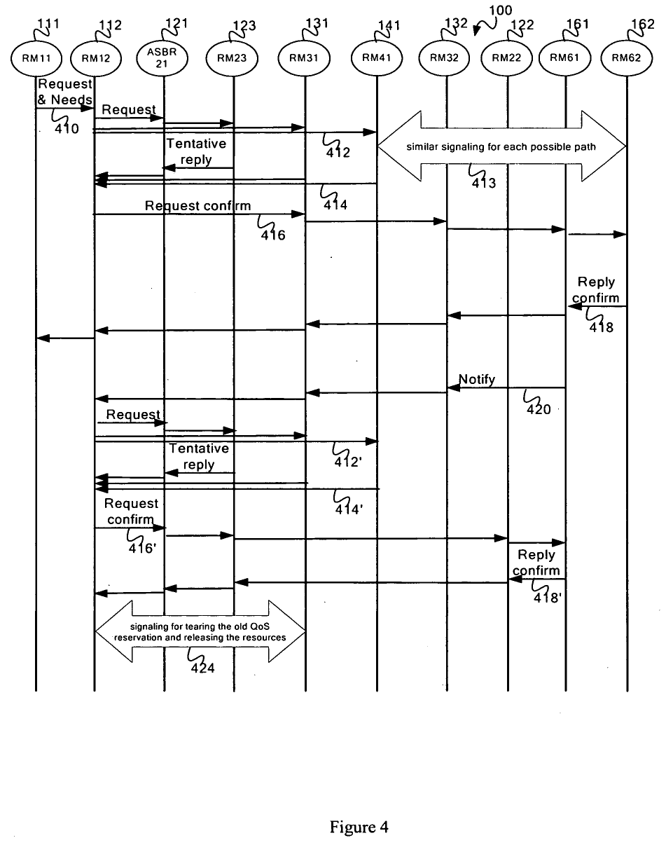

FIG. 4 shows a message sequence flow chart of an exemplary setup and update of a QoS reservation between a first node in a first AS and a second node in a second AS in accordance with the teachings of the present invention. The example of FIG. 4 refers to the network topology shown in FIG. 1. The RM11 111 wants to establish an inter-domain QoS reservation to AS6 160. FIG. 4 shows, step by step, the signaling that takes place between the RMs that play a part in the inter-domain QoS reservation determination from the RM11 111 to RM62 162. This signaling process begins when RM11 111 receives or senses the need to establish an inter-domain QoS reservation to the AS6 160 that will sustain at least one QoS characteristics. The RM11 111 and the RM62 162 are both border routers.

Since the RM11 111 has knowledge of its AS′ topology, it finds the best route inside the AS1 110 and sends appropriate messages (not shown) to temporarily reserve resources for therein. The duration of the temporary reservation is to be determined, for instance, in view of the traffic type and network activity type and is not subject to the present invention. The RM11 111 thus sends a request message 410 to its ASBR/RM12 112. The request message 410 contains destination requirement, along with at least one QoS characteristic to be fulfilled by the inter-domain QoS reservation being established. The RM12 112 then sends a request message 412 message to its adjacent ASs via the ASBR21 121, the RM31 131 and the RM41 141. Since the ASBR21 121 does not have the Resource Manager functionalities, it forwards the request message 412 to the RM 123. Each of the RMs receiving the request message 412 replies to PCE12 with a tentative reply message 414 that informs the RM12 112 of the level of QoS they each are able to obtain for the required destination. Each of the RM further acts to temporarily reserve (likely to be a small amount of time since the request 412 originates from another AS) the resources advertised in the tentative reply message 414. The steps 412 and 414 could be repeated for other ASs, if appropriate as shown by the box 413. The RM12 112 then decides of the best alternative, for instance, the RM31 131, and sends a request confirm message 416 thereto. The RM31 131 then refreshes the temporary reservation already in place the AS3 130. The RM23 123 and the RM41 141 release the resources they reserved either actively upon expiration of the temporary reservation or implicitly if a duration of the temporary reservation was given at the same time the temporary reservation was requested. The RM31 131 then sends the request confirm message 416 to its ASBR/RM32 132. The RM32 132 then sends the a request message (not shown) to its adjacent ASs, the RM61 161 in this case. The RM61 finds the best path inside the AS6 160, reserves it, and sends the request confirm message 416 to its ASBR/RM62 162, which detects that it is the destination point of the requested inter-domain QoS reservation. The RM62, 61, 32, 31, and 12 respectively reply to the request confirm messages 416 with a reply confirm message 418. When the RM11 111 receives this reply confirm message 418, it knows that the Path returned is an acceptable and potentially optimal path to the desired destination and that the resources for it are ‘reservable’ for the inter-domain QoS reservation.

The exchanged messages are the request message 412, request-confirm message 416, tentative reply message 414 and reply confirm message 418. The request message 412 alone does not perform any reservation. The tentative reply message 414 alone performs a temporary reservation for a short period of time, i.e. period of time necessary for waiting to receive the request confirm message 416 to confirm the inter-domain QoS reservation. Upon receiving the request confirm message 416, the resources will be reserved for a longer period of time, i.e. until receiving a reply confirm message 418 from the end point side of the path. Upon receiving the reply confirm message 418, the resources' reservation will be valid for a longer time. For clarity reasons, the example of FIG. 4 does now show the reply messages and request confirm messages exchanged between PCEs belonging to the same AS.

FIG. 4 further shows an example of signaling messages exchanged when a need to modify the inter-domain QoS reservation is detected is detected on a link in the path of the inter-domain QoS reservation. It is assumed that the ASBR/RMs in the path of the inter-domain QoS reservation have retained the state of the optimized path for future re-optimization. The RM61 161 thus detects a reason to modify the inter-domain QoS reservation (e.g. congestion causing QoS degradation) and notifies the RM32 with a Notify message 420. Since the RM32 132 cannot provide an alternate path to the destination, it forwards the notify message 420 to the RM31 131. For the same reason, the RM31 131 forwards the notify message 420 to the RM12 112. The RM12 112 then sends a request message 412′ similarly to the request message 412. The RM12 112 could include the RM 131 from which it received the notify message 420 or not, depending on the cause of the modification request (e.g. a failure would not trigger inclusion of the RM31 131 on the destination list while a period refresh would). The ASBR21 121 thus forwards the request message 412′ to the RM23 123, which replies, just like the RM41 141 with a tentative reply message 414′ that will inform the RM12 112 of the level of QoS they are able to obtain for the required destination. The RM12 112 then decides of the best alternative, through the AS2 120 in this example, and sends a request confirm message 416′ thereto. The ASBR21 121 thus forwards the request confirm message 416′ to the RM23 123, which temporarily reserves the path resources inside the AS2 120. The other ASs release the resources it reserved in this case. The RM23 123 then sends the request confirm message 416′ to its ASBR/RM22 122, which sends the request confirm message 416′ to its adjacent ASs, the AS6 160 in this case. The receiver (i.e. the RM61 161) then matches the request confirm message 416′ to the already existing path inside the AS6 160. The matching could be performed with the use of a path-request ID in the request message 416′, but many other methods could be used. The RM61 161 then replies to the request confirm message 416′ with a reply confirm message 418′, which is thereafter forwarded back to the RM12 112. Upon reception thereof, the RM12 112 knows that the path returned is acceptable and maybe optimal and it re-establishes the inter-domain QoS reservation from the RM12 112 to the RM61 161 by taking the path through AS2 120. The RM12 112 could then finally signal the RM31 131 to release the resources for the inter-domain QoS reservation, if appropriate (step 424).

The preceding example considered a congestion scenario. The same kind of signaling can be used in case of failure detection. Moreover, a similar signaling can be used at regular intervals to constantly re-optimize the end-to-end path taken by the inter-domain QoS reservation or part of it.

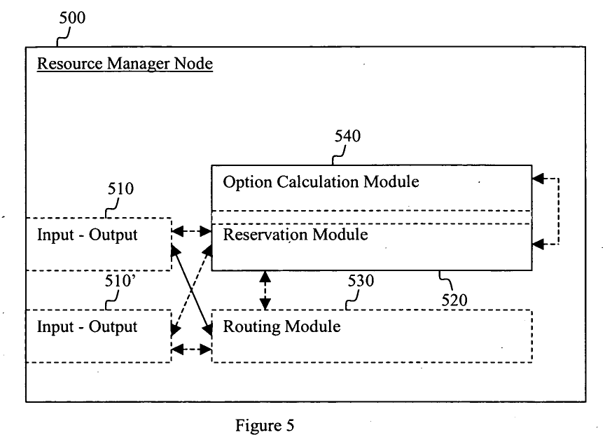

FIG. 5 shows a modular representation of a RM 500 in accordance with the teachings of the present invention. The RM 500 is likely to have at least one input-output port or means 510 and 510′ for receiving and sending packets. It could however be collocated to another device which acts as an input-output means. The RM 500 comprises a reservation module 520 comprising means for conducting the logic presented above, for instance, in FIGS. 2-4. The RM 500 could further comprise a routing module 530 for performing regular tasks of a typical router. The routing module 530 could interact with the reservation module 520 and vice-versa. The RM 500 further comprises an option calculation module 540 comprising means for conducting the logic presented above, for instance, in FIGS. 2-4. The distribution of functionalities between the modules 520 and 540 does not limit the teachings of the present invention. It can however be advantageous to delegate tasks requesting higher processing needs to the option calculation module 540, which could be further optimized therefor. Not shown on FIG. 5 is the underlying hardware architecture (e.g. memory, processor, data storage, etc.) of the RM 500 since it does not affect the teachings of the present invention.

Although several examples of the present invention have been illustrated in the accompanying drawings and described in the foregoing description, it will be understood that the invention is not limited to the embodiments disclosed, but is capable of numerous rearrangements, modifications and substitutions without departing from the teachings of the present invention. In general, statements made in the description of the present invention do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

What is claimed is:

1. A method for establishing an inter-domain QoS reservation between a first node in a first domain and a second node in a second domain, the first and second domains being connected via a series of routers, the method comprising the steps of:
detecting, at the first node, that the inter-domain QoS reservation with at least one QoS characteristic is needed;
obtaining, at the first node, network state information associated to the first domain;
obtaining, at the first node, network state information associated to at least one possible choice of path between the first domain and the second domain;
determining, at the first node, at least one choice of path between the first node and the second node in view of the at least one QoS characteristic;
selecting, at the first node, from the at least one choice of path a selected path to support the inter-domain QoS reservation; and
sending, from the first node and addressed to the second node, a reservation message to trigger establishment of the inter-domain QoS reservation.

2. The method of claim 1 wherein the step of determining is performed by:
determining, at the first node, at least one choice of end-to-end path between the first node and the second node respecting the at least one QoS characteristic.

3. The method of claim 1, wherein the step of obtaining network state information associated to the first domain further comprises:
sending, from the first node and addressed to an intermediate node of the first domain from the series of routers, a temporary request message to temporarily reserve resource for eventual establishment of the inter-domain QoS reservation; and
receiving a tentative reservation message from the intermediate node of the first domain, the tentative reservation message comprising the network state information associated to the first domain is included.

4. The method of claim 1, wherein the step of obtaining network state information associated to the at least one possible choice of path between the first domain and the second domain further comprises:
sending, from the first node and addressed to an intermediate node outside the first domain from the series of routers, a temporary request message to temporarily reserve resource for eventual establishment of the inter-domain QoS reservation; and
receiving a tentative reservation message from the intermediate node outside the first domain, the tentative reservation message comprising the network state information associated the at least one possible choice of path between the first domain and the second domain is included.

5. The method of claim 3, wherein the step of obtaining network state information associated to the at least one possible choice of path between the first domain and the second domain further comprises:
sending, from the first node and addressed to an intermediate node outside the first domain from the series of routers, a temporary request message to temporarily reserve resource for eventual establishment of the inter-domain QoS reservation; and
receiving a tentative reservation message from the intermediate node outside the first domain, the tentative reservation message comprising the network state information associated the at least one possible choice of path between the first domain and the second domain is included.

6. The method of claim 1, wherein the step of obtaining network state information associated to the at least one possible choice of path between the first domain and the second domain further comprises:
obtaining information related to the at least one QoS characteristic reservation from an existing table.

7. The method of claim 1 wherein the step of determining the at least one choice of end-to-end path comprises:
concatenating, at the first node, the network state information associated to the first domain with the network state information associated to the at least one possible choice of path between the first domain and the second domain in order to determine if the at least one choice of end-to-end path respecting the at least one QoS characteristics exists.

8. The method of claim 1 wherein the step of determining the at least one choice of end-to-end path comprises:
calculating, at the first node, a QoS value for each of at least one path external to the first domain toward the second node.

9. The method of claim 1, wherein the step of sending the reservation message further comprises:
sending, from the first node and addressed to the second node, a confirm request message, the confirm request message comprising sufficient information to be routed in accordance with the select path; and
receiving a reservation confirm message, which established the inter-domain QoS reservation on its path from the second node to the first node.

10. The method of claim 1 wherein the method is further executed again starting from the step of determining if a reservation confirm message is not received at the first node after a specific period following the step of sending the reservation message.

11. A method for modifying an established inter-domain QoS reservation maintained on an end-to-end path between a first node in a first domain and a second node in a second domain, the first and second domains being connected via a series of routers, the method comprising the steps of:
detecting, at an intermediate node of the series of routers, that the inter-domain QoS reservation with at least one QoS characteristic needs to be refreshed;
obtaining, at the intermediate node, network state information associated to its domain;
if the domain of the intermediate node is not the second domain:
obtaining, at the intermediate node, network state information associated to at least one possible choice of path between the domain of the intermediate node and the second domain;
determining, at the intermediate node, at least one alternate choice of path between the intermediate node and the second node respecting the at least one QoS characteristic;
selecting, at the intermediate node, from the at least one alternate choice of path a selected path to support the inter-domain QoS reservation; and
if the selected path changes the end-to-end path of the inter-domain QoS reservation toward the second node:
sending, from the intermediate node and addressed to the second node, a reservation message to trigger establishment of the inter-domain QoS reservation.

12. The method of claim 11 further comprising the steps of:
after detecting, verifying that the intermediate node can find an alternate path toward the second node; and
if it cannot, sending a notify message from the intermediate node toward the first node via the series of routers, the notify message comprising sufficient information to let a further node of the series of routers know that the inter-domain QoS reservation with at least one QoS characteristic needs to be refreshed.

13. The method of claim 11 further comprising a step of, if the selected path does not change the end-to-end path of the inter-domain QoS reservation toward the second node:
sending a notify message from the intermediate node toward the first node via the series of routers, the notify message comprising sufficient information to let a further node of the series of routers know that the inter-domain QoS reservation with at least one QoS characteristic needs to be refreshed.

14. A Resource Manager Node (RM) for establishing and modifying an inter-domain QoS reservation on an end-to-end path between a first node in a first domain and a second node in a second domain, wherein the RM is on the end-to-end path and comprises:
a reservation module:
detecting that the inter-domain QoS reservation with at least one QoS characteristic is either needed or needs to be refreshed;
obtaining network state information associated to at least one possible choice of path between the RM and the second domain; and
sending, from the RM and addressed to the second node, a reservation message to trigger establishment of the inter-domain QoS reservation; and
an Option calculation module:
determining at least one choice of path between the RM and the second node respecting the at least one QoS characteristic; and
selecting from the at least one choice of path a selected path to support the inter-domain QoS reservation.
